(19) United States
(12) Patent Application Publication
(10) Pub. No.: US 2003/0143339 A1
(43) Pub. Date: Jul. 31, 2003

(54) Method of treatment for water repellancy, thin film forming method and method of manufacturing organic EL device using this method, organic EL device, and electric device

(75) Inventor: Hidekazu Kobayashi, Hara-mura (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/310,162

(22) Filed: Dec. 5, 2002

(30) Foreign Application Priority Data
Dec. 26, 2001 (JP) 2001-395398
Nov. 27, 2002 (JP) 2002-343968

(51) Int. Cl. B05D 5/12; B05D 3/06

(52) U.S. Cl. 427/558; 427/66

(57) ABSTRACT

In a method of treating a substrate for water repellency, there is a method of coating with a fluor-alkyl processing agent in the atmosphere or in a vacuum, however this takes time, and foreign matter becomes attached. A substrate surface is irradiated with ultraviolet light while flowing a fluoridated gas thereover to treat for water repellency. Moreover a thin film is formed inside a partition by this method and an organic EL device if manufactured by a liquid phase method. To be specific, scrub cleaning, UV ozone cleaning, an ultraviolet fluoridization process, an organic film forming is performed using an ink jet method, a cathode film forming and a sealing are performed.

### BACKGROUND OF THE INVENTION

1. Field of the Invention

The present invention relates to a method of treating the surface of a substrate used in displays, semiconductor processes and the like, and a thin film forming method. Furthermore, the invention relates to a method of manufacturing an organic EL device used for computer terminals or the like, television displays, the display section of portable equipment, and the like. Moreover, it relates to this organic EL device. Furthermore, it relates to electronic devices using this.

2. Background Art

Heretofore, for methods of making the surface of a substrate water repellent, there are known; a method of treating automobile windscreens with a coupling agent containing a fluorinated alkyl group, a method of treating using a fluoride gas plasma excited by an electric field as used for etching in semiconductor processes, a method of coating with a water repellent material in order to give water repellency to clothes, and the like (refer to Japanese Unexamined Patent Application, First Publication No. 2000-353594 (Japanese Patent Reference 1)).

For a method of treating substrates used for displays, in the method of treating with a coupling material containing an alkyl group, the equipment becomes large if vapor phase is used, thus the cost is high. Furthermore, since a film is formed uniformly over the structure of the substrate surface, this has a problem in that the treatment cannot be applied to only a film with specific properties on the substrate. For the method of treating using fluoride gas plasma excited by an electric field, there are problems that, if using a vacuum, throughput cannot be increased since it is a batched treatment, and if performed at atmospheric pressure then contamination from discharge electrodes cannot be ignored. In the method of coating with water repellent material, the film becomes thick, and furthermore, since a film is formed uniformly over the structure of the substrate surface, there is a problem that the treatment cannot be applied to only a film with specific properties on the substrate.

### SUMMARY OF THE INVENTION

A method of treatment for water repellency of the present invention is a method of treating the surface of a substrate for water repellency, wherein ultraviolet irradiation is performed in a state where the substrate is exposed in an atmosphere of a fluoride-containing gas. The present structure enables the surface of a substrate to be made water repellent speedily in an atmosphere at atmospheric pressure and in very clean conditions.

Here, water repellency means a characteristic of repelling liquid material being the object (for example, a solution in which a thin film material is dissolved), and it does not matter if this liquid material is hydrophilic or lipophilic.

In this method of treatment for water repellency, the ultraviolet irradiation is performed with a wavelength of 300 nm or less. The present construction enables effective radical decomposition of a fluoride-containing gas, thus enabling effective fluoridation of the surface of a substrate.

A thin film forming method of the present invention is a method of forming a thin film in a predetermined region on a substrate, comprising a partition forming process for forming a partition from an organic film on the substrate so as to surround the predetermined region, a water repellent treatment process for irradiating the partition with ultraviolet light in a state where the substrate is exposed in an atmosphere of a fluoride-containing gas, a discharge process for discharging a solution in which the thin film material is dissolved into the region surrounded by the partition, and a drying process for drying the solution and removing the solvent. Alternatively, the thin film forming method of the present invention is a method of forming a laminate of thin film in a predetermined region on the substrate, comprising a partition forming process for forming a partition from an organic film on the substrate so as to surround the predetermined region, a water repellent treatment process for irradiating the partition with ultraviolet light in a state where the substrate is exposed in an atmosphere of a fluoride-containing gas, a discharge process for discharging a solution in which the thin film material is dissolved into the region surrounded by the partition, and a drying process for drying the solution and removing the solvent, and a laminate of thin film is formed by repeating the discharge process and the drying process while changing the thin film material.

In the present forming method, the solution in which a thin film material is dissolved is the object of water repellency. In the present forming method, in the water repellent treatment process the components of the partition surface are partially radicalized by ultraviolet light, a fluoride-containing gas is similarly decomposed and radicalized, and a radical containing fluorine and a radical existing on the partition surface are combined. As a result, molecules containing fluorine are introduced to the partition surface, and water repellency is imparted to the partition. Then, when the abovementioned solution is discharged into a predetermined region within the partition that has been made water repellent, a solution that is splashed onto the top end face or the side face of the partition is repelled at the partition surface and flows into the predetermined region, so that the solution can be placed in only the predetermined region. Then, by removing the solvent by a drying process, it is possible to form a thin film material in only the predetermined region. Furthermore, by repeating the discharge process and the drying process while changing the thin film material, it is possible to form a laminate of thin film material in only the predetermined region. Here, the partition may be of any type so long as it can partition the substrate surface into a plurality of regions. For example, it may include a feature called a bank in the field of organic EL devices.

In this manner, according to the present forming method, it is possible to form a thin film material with good accuracy in a required region. Furthermore, since the present manufacturing method does not use a vacuum process, throughput can be improved.

Here, a process for irradiating the substrate surface with ultraviolet light, in a state where the substrate is exposed in an atmosphere of an oxygen-containing gas that generates active oxygen radicals by ultraviolet irradiation, may be provided between the partition forming process and the water repellent treatment process.

According to the present forming method, since active oxygen radicals generated by ultraviolet irradiation react with organic substances on the substrate surface, and the organic substances are decomposed and removed, it is possible to clean the substrate surface.

Furthermore, a process for scrubbing the surface of the substrate to clean it may be provided between the partition forming process and a hydrophobicity process. In this manner, it is possible to achieve further cleaning of the substrate surface.

The above described discharge process is preferably performed using an ink jet method. By so doing, it is possible to discharge a solution into the predetermined region accurately.

A manufacturing method of an organic EL device of the present invention is a manufacturing method of an organic EL device having a structure in which at least a luminescent layer is sandwiched between a first electrode and a second electrode, wherein a resin bank is formed on a substrate so as to surround the first electrode pattern, the surface of this substrate is irradiated with ultraviolet light while exposed in an atmosphere of oxygen-containing gas, and is then irradiated with ultraviolet light while exposed in an atmosphere of fluoridated gas, then positive hole injection material and/or luminescent material films are formed, then subsequently a cathode forming process, and furthermore a sealing process are performed. The present construction enables surface processes and film processes to be performed in a state where the number of foreign substances on the substrate is controlled to be 30 parts/cm² or less. As a result, it is possible to create an organic EL device with excellent initial characteristics and high reliability. Furthermore, because it is an atmospheric pressure process, no time is required to create a vacuum, thus enabling a proportionate improvement in throughput.

In the manufacturing method of this organic EL device, the method of forming the positive hole injection material and/or the luminescent material films is an ink jet method. The present process enables a positive hole injection layer or a luminescent layer to be formed in a picture element accurately.

In this manufacturing method of an organic EL device, immediately before ultraviolet irradiation while exposed in an atmosphere of the gas containing oxygen, the surface of the substrate is cleaned by scrubbing. The present construction enables foreign substances on the substrate to be removed effectively, and also prevents foreign substances from increasing in subsequent processes enabling flow.

An organic EL device of the present invention is manufactured by the above-described manufacturing method of an organic EL device. According to the present construction, it is possible to realize an organic EL device with almost no contamination by foreign substances, thus enabling a significant improvement of both initial characteristics and reliability.

In any one of the method of treatment for water repellency, the thin film forming method, and the organic EL device manufacturing method, it is preferable that the fluoride-containing gas contains at least one of a fluorine derivative product (fluoride substitution product) of methane gas, a fluoride substitution product of ethylene gas, and a gas in which fluorine is combined with hetero atoms. Furthermore, it is preferable that ultraviolet irradiation is performed with a wavelength of 300 nm or less, and it is particularly desirable that the wavelength is approximately 174 nm.

An electric (electronic) device of the present invention is characterized in that it is fitted with an organic EL device as described above. According to the present construction, it is possible to realize an electric device with a high quality display and long life.

As described above, the present invention enables the surface of a substrate to be made water repellent easily. Furthermore, by using this water repellency process in the manufacture of an organic EL device, it is possible to make the process clean, so that an organic EL device display manufactured by this process is made uniform, and there is an effect in that display life becomes longer. Furthermore, the display section of an electric device into which this organic EL device is fitted is easy to read, and display life becomes longer.

### BRIEF DESCRIPTION OF THE DRAWINGS

FIG. 1 is a conceptual diagram showing a water repellency process of an embodiment of the invention.

FIG. 2 shows a hydrophilic process of the embodiment of the invention.

FIG. 3 shows a water repellency process of the embodiment of the invention.

FIG. 4 shows an organic layer film forming process of the embodiment of the invention.

FIG. 5A through FIG. 5C show a forming process of a positive hole injection layer and a luminescent layer of the embodiment of the invention.

FIG. 6 is a plan view showing the head of an ink jet device used when manufacturing an organic EL device of the embodiment of the invention.

FIG. 7 is a plan view showing the ink jet device used when manufacturing the organic EL device of the embodiment of the invention.

FIG. 8 shows a cathode film forming process of the embodiment of the invention.

FIG. 9 shows a mobile phone of an embodiment 2.

### DETAILED DESCRIPTION OF THE PREFERRED EMBODIMENTS

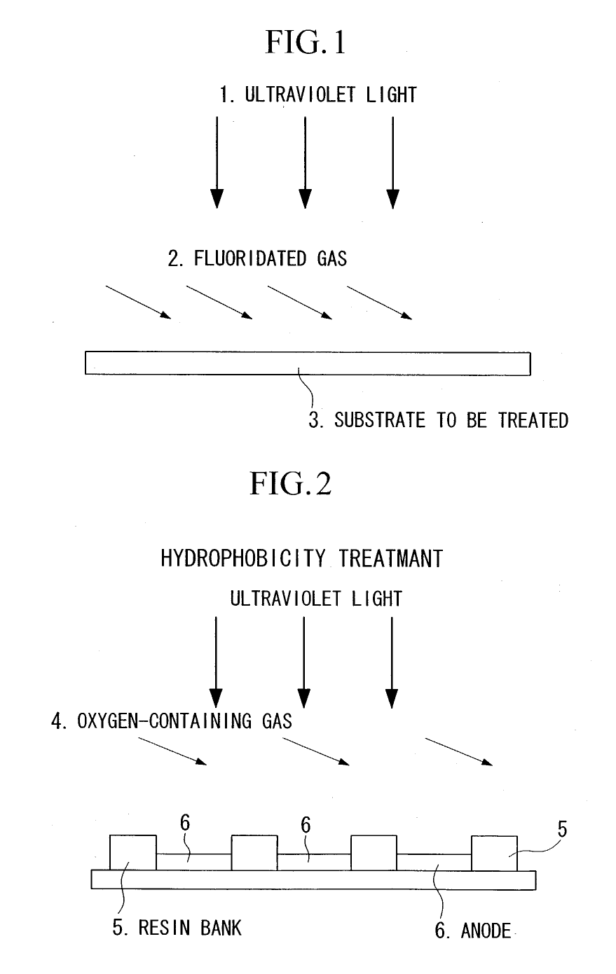

FIG. 1 is a simple conceptual diagram showing a method of treatment for water repellency of the present invention in an optical device according to the present invention, and is described hereunder. It is desirable that the surface of a substrate to be given water repellency treatment is formed as an organic film for better water repellency. The principle of water repellency will be described. If an area to be made water repellent on a substrate is irradiated with ultraviolet light in the presence of a fluoridated gas, the components are partially radicalized by the ultraviolet light. Furthermore, the fluoridated gas is similarly decomposed and radicalized, and radicals containing fluorine and radicals existing on the substrate are combined, so that it is possible to introduce fluorine atoms or molecules containing fluorine onto the surface of the substrate. By so doing, it is possible to make the substrate water repellent. Accordingly, if the ultraviolet light used here has high energy then it improves the efficiency of fluoridation, so it is desirable that its wavelength is 300 nm or less. Furthermore, the output power and irradiation time of ultraviolet light are approximately 200W and 30 seconds respectively. Sufficient fluoridated gas needs to be introduced to displace the air atmosphere entirely. If there is insufficient displacement at the substrate surface (1% concentration or more of oxygen), then sufficient water repellency cannot be obtained. It is desirable that the oxygen concentration is 0.1% or less.

Next is shown an example in which this method of treatment for water repellency is applied to a manufacturing method of an organic EL device with a construction in which at least one luminescent layer is sandwiched between an anode and a cathode. FIG. 2 through FIG. 5 show a conceptual diagram of the present embodiment.

FIG. 2 shows a hydrophilic process, wherein ultraviolet light 1 irradiates the surface of a substrate, on which resin banks (partitions) are formed so as to surround patterned electrodes, while exposed in an atmosphere of an oxygen-containing gas 4. In this process, typically used resin films that can be produced as a patterned film, such as polyimide, acrylic resins, polycarbonate, polyester, polyethylene, polypropylene, fluoride alkyl group resin, polyethersulfone, and the like, can be used for the resin banks. Furthermore, an active component such as a TFT may be formed on the substrate used. For an oxygen-containing gas to flow onto this substrate, a gas that generates active oxygen radicals by ultraviolet irradiation, such as oxygen, air, ozone or the like can be used. These active oxygen radicals react with organic substances on an ITO surface, and decompose and remove the organic substances. Moreover, they increase the work function on the anode at the same time, thus increasing the efficiency of positive hole injection to organic layers. Furthermore, on the surface of the resin banks, carbon-hydrogen bonds in the resin material are cut, generating radicals, and oxygen atoms and the like are combined, thus making it water repellent. The direction of spraying this oxygen-containing gas onto the substrate is not limited to the direction shown in the figure, and it may be from the front. It is desirable that the wavelength of the ultraviolet light used at this time is 300 nm or less. Moreover, the output power and irradiation time of the ultraviolet light are approximately 200W and 30 seconds respectively. For the oxygen concentration on the substrate surface, 1% or more would give a sufficient water repellency effect. By scrub cleaning the substrate surface before this hydrophilic process, it is possible to remove foreign substances on the substrate effectively. To be specific, by scrub cleaning a substrate that had 100 parts/cm² or more of foreign substances, and further by performing UV ozonization (ultraviolet light with a wavelength about 174 nm), the number of foreign substances could be reduced to 10 parts/cm² (the foreign substances were confirmed by a dark-field microscope).

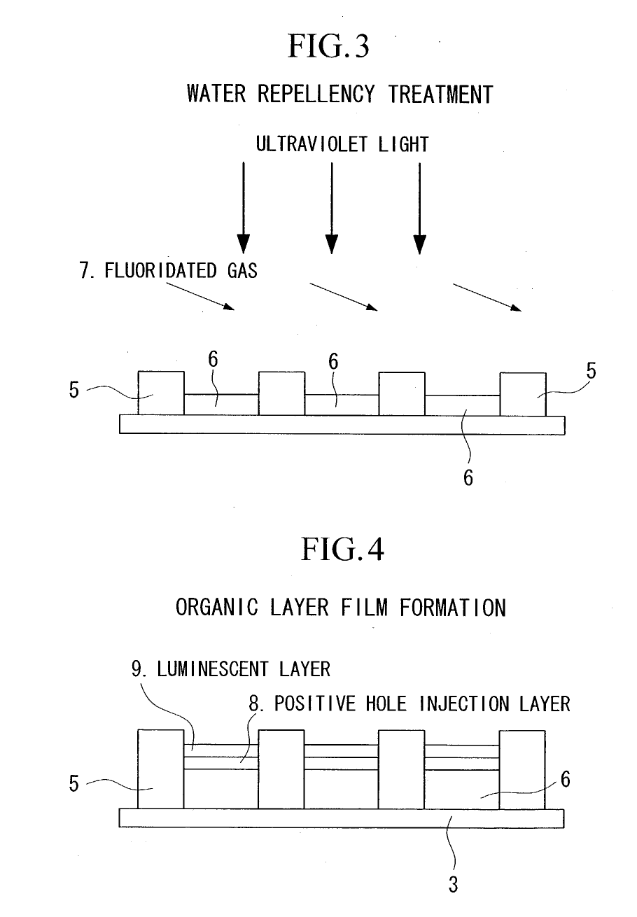

FIG. 3 shows a water repellency process. Ultraviolet irradiation is performed while the substrate is exposed in an atmosphere of fluoridated gas 7 after the hydrophilic process. By this process, fluorine is combined with the resin surface on the resin bank to make it water repellent. However, the surface of the ITO does not change, maintaining hydrophilicity. For fluoridated gasses used in this process, it is also possible to use fluorine derivative products (fluoride substitution products) of methane gas, such as CF₄, CHF₃, CH₂F₂ and CH₃F, fluorine derivative products (fluoride substitution products) of ethylene gas, such as CH₃—CF₃ and CHF₂—CHF₂, and gas in which fluorine is combined with hetero atoms, such as NFH₂ and NF₂H. In the present process, molecules on the resin bank surface are radicalized by ultraviolet light, the fluoridated gas is similarly radicalized, these radicals are combined, and the surface of the bank is fluorinated. It is desirable that the wavelength of the ultraviolet light used at this time is 300 nm or less.

FIG. 4 is a diagram showing the production of positive hole injection layer and luminescent layer films using a liquid phase method. Firstly, after the water repellency process, if a positive hole injection layer is formed by an inkjet method, a printing method or the like, the surface of the electrode that forms a picture element remains hydrophilic, and the resin bank is made water repellent. Therefore, if a solution in which positive hole injection material is dissolved is patterned on the picture element by an inkjet method, a printing method or the like, solution splashed onto the bank is directed into the picture element, and settles only inside the picture element, so that the positive hole injection material forms a film inside the picture element accurately. For a positive hole injection material used in this process, it is possible to use a solution containing a material having positive hole injection property, such as BytronP made by Bayer Ltd., an electroconductive polymer, such as polyaniline and polypyrrole, MTDATA, a phenylamine derivative, copper phthalocyanine or the like. For a solution of luminescent material, it is possible to use a solution containing a polyparaphenylene vinylene derivative, a polydialkylfluorene derivative, aluminoquinolinium complex, DPVBi or the like. After film formation, the solvent is removed by drying.

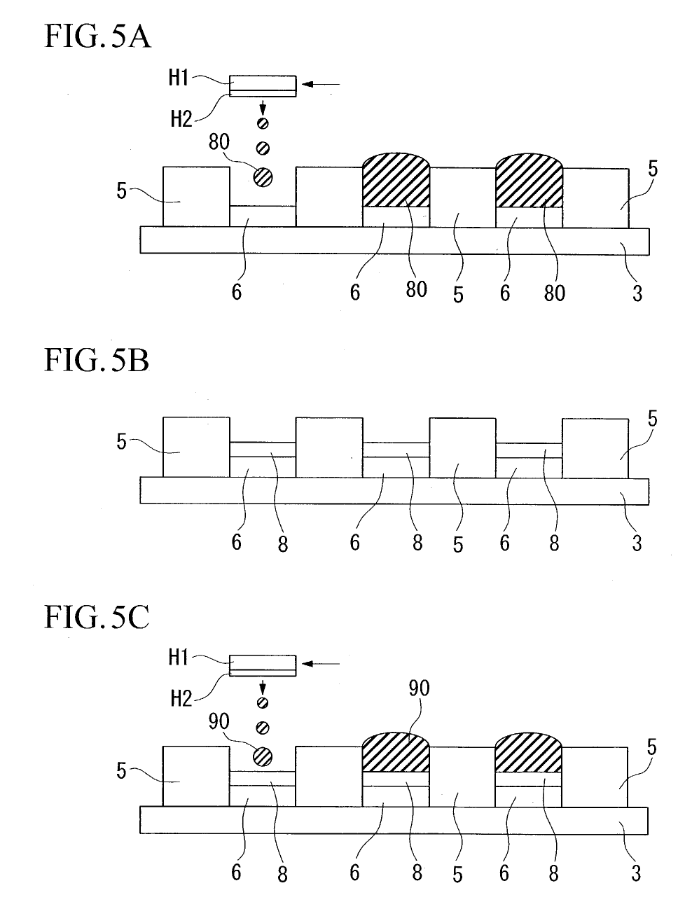

FIG. 5 shows an example of a process of forming a positive hole injection layer 8 and a luminescent layer 9. Here, a forming method using an inkjet device is described.

Firstly, a substrate 3 is prepared on which a plurality of anodes 6 is formed, and resin banks 5 are patterned around the anodes 6 so as to partition the surface of the substrate into regions where each of the anodes 6 is formed. Then, as shown in FIG. 5A, a first solution 80 containing a positive hole injection layer forming material (thin film material) is discharged onto each of the regions partitioned by the banks 5 from a plurality of nozzles H2 formed in an inkjet head H1. Here, by scanning with the inkjet head H1, the solution fills each picture element. However, this is also possible by scaning the substrate 3. Furthermore, by moving the inkjet head H1 and the substrate 3 relatively, it is also possible to fill with the solution 80. The points described above are the same in all the processes using an inkjet head hereafter.

The inkjet head H1 is discharged as follows. That is, the discharge nozzles H2 formed in the inkjet head H1 are positioned facing the anodes 6, and drops of the first solution 80 are discharged onto the anodes 6, with the amount of liquid per drop being controlled.

Here, the same material may be used for the positive hole injection/transport layer forming material for each of the luminescent layers red (R), green (G) and blue (B), or it may be changed for each luminescent layer.

As shown in FIG. 5A, the discharged first solution 80 spreads over the surface of the anode, which is lyophilic treated, and fills the picture element. Even if the first solution 80 is discharged onto the top face 51 of the bank 5, departing from a predetermined discharge location, the top face 51 is not wetted by the first solution 80, and the repelled first solution 80 flows into the picture element from the side faces of the bank 5.

The amount of the first solution 80 discharged onto the anode 6 is determined by the size of the picture element, the thickness of the positive hole injection layer 8 to be formed, the concentration of the positive hole injection layer forming material in the first solution, and the like.

Furthermore, the drops of the first solution 80 may be discharged onto the same anode 6 not only once but also several times. In this case, the amount of the first solution 80 may be the same each time, or the amount of the first solution 80 may be changed each time. Moreover, the first solution 80 may be discharged not only onto the same place of the anode 6 but also onto different places in one picture element each time.

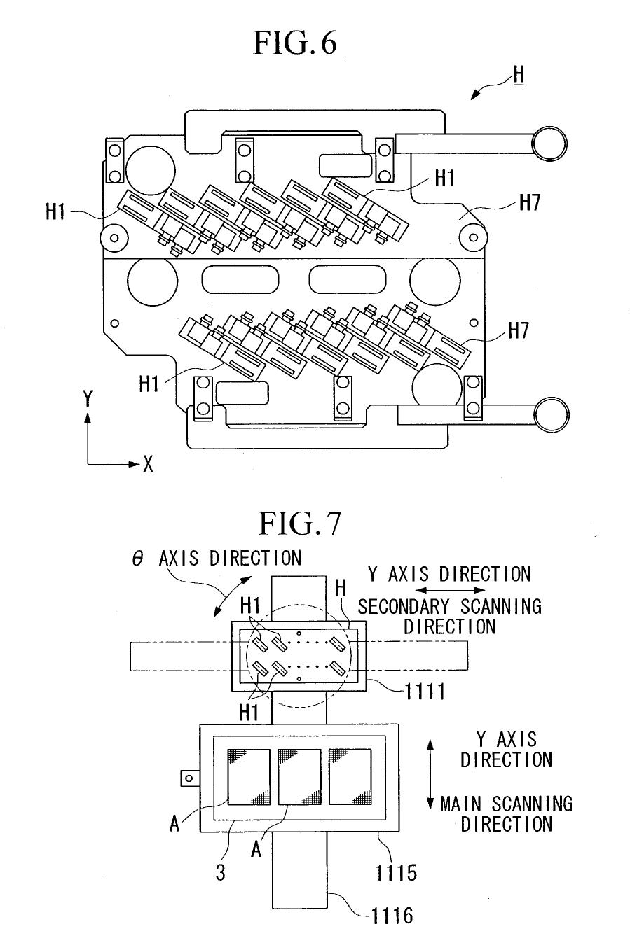

For a structure of an inkjet head, a head H as in FIG. 6 can be used. Furthermore, it is preferable to locate the substrate and the inkjet head as in FIG. 7. In FIG. 6, symbol H7 denotes a support substrate for supporting the aforementioned inkjet head H1, and a plurality of inkjet heads HI is provided on this support substrate H7.

On the ink discharge faces (faces opposite the substrate) of the inkjet heads HI, a plurality of discharge nozzles (for example 180 nozzles per row, 360 nozzles in total) is provided in rows along the lengthwise direction of the head, and in two rows spaced in the widthwise direction of the head. Furthermore, a plurality (6 pieces in one row, 12 pieces in total in the figure) of inkjet heads H1, with their discharge nozzles facing the substrate side, is positioned on and supported by the supporting plate H7, which is almost rectangular in the plan view, in rows along the X axis direction, inclined toward the X axis (or the Y axis) by a prescribed angle, and arranged in two rows at prescribed spacing in the Y direction.

Furthermore, in the inkjet device as shown in FIG. 7, numeral 1115 denotes a platform onto which the substrate 3 is mounted, and numeral 1116 denotes a guide rail for guiding the platform 1115 in the X axis direction (main scanning direction) in the figure. The head H can move in the Y axis direction (secondary scanning direction) in the figure on a guide rail 1113 via a supporting member 1111. Moreover, the head H can revolve in a θ axis direction in the figure, to incline the inkjet heads H1 by a predetermined angle in the main scanning direction. In this manner, by positioning the inkjet heads inclined toward the main scanning direction, it is possible to match nozzle pitch to picture element pitch. Furthermore, by adjusting the inclination angle, it is possible to match it to any picture element pitch.

The substrate 3 as shown in FIG. 7 has a structure in which a plurality of chips is placed on a mother substrate. That is, one chip region corresponds to one display device. Here, three display regions A are formed. However, it is not limited to this. For example, in a case where a solution is coated onto the display region A on the left side on the substrate 3, the head H is moved to the left side via the guide rail 1113, the substrate 3 is moved to the top side in the figure, and coating is performed by scanning the substrate 3. Next, the head H is moved towards the right side in the figure, and a solution is coated onto the display region A in the center of the substrate. The same as just described is also performed on the display region A on the right.

Here, the head H as shown in FIG. 6 and the inkjet device as shown in FIG. 7 may be used not only for the positive hole injection layer forming process but also for the luminescent layer forming process.

Next, a drying process is performed as shown in FIG. 5B. By performing the drying process, the first solution 80 is dried after being discharged, polar solvent contained in the first solution 80 is evaporated, and a positive hole injection layer 8 is formed with uniform film thickness.

The above-described drying process is performed in, for example, an atmosphere of nitrogen with for example about 133.3 Pa (1 Torr) of pressure at room temperature. If the pressure is too low, the drops of the first solution 80 bubble, which is not desirable. Furthermore, if the temperature is higher than room temperature, the evaporation speed of the polar solvent increases, which prevents a flat film from being formed.

After the drying process, it is preferable to remove polar solvent or water remaining in the positive hole injection layer 8 by heat treatment in nitrogen, preferably in a vacuum, at 200° C. for about ten minutes.

Next, as shown in FIG. 5C, a second solution 90 containing a luminescent layer forming material (thin film material) is discharged onto the positive hole injection layer 8 by an inkjet method, similarly to the positive hole injection layer 8 forming process as mentioned previously. Afterwards, the discharged second solution 90 is dried (or heat treated), the solvent is removed, and a luminescent layer 9 is formed on the positive hole injection layer 8.

Drying is carried out, for example in the case of a blue luminescent layer, in an atmosphere of nitrogen at a pressure of about 133.3 Pa (1 Torr) at room temperature for 5 to 10 minutes. If the pressure is too low, the drops of the second solution 90 bubble, which is not desirable. Furthermore, if the temperature is higher than room temperature, the evaporation speed of the non-polar solvent increases, and the thickness of the luminescent layer becomes non-uniform, which is not desirable. Moreover, in the cases of a green luminescent layer and a red luminescent layer, since there is a large number of components in the luminescent layer forming material, it is preferable to dry it quickly, so the condition may be that nitrogen is blown at 40° C. for 5 to 10 minutes, for example.

Other drying methods are, for example, a far infrared radiation irradiation method, a high temperature nitrogen gas jet method and the like.

Here, in the luminescent layer forming process, in order to prevent the positive hole injection layer 8 from being re-dissolved, a non-polar solvent that is insoluble to the positive hole injection layer 8 is used as a solvent of the second solution 90 when forming the luminescent layer.

However, alternatively, since the positive hole injection layer 8 has a low affinity with non-polar solvent, even if the second solution 90 containing a non-polar solvent is discharged onto the positive hole injection layer 8, there is a concern that the positive hole injection layer 8 and the luminescent layer 9 will not adhere, or that the luminescent layer 9 will not be coated uniformly.

Therefore, in order to increase the affinity of the surface of the positive hole injection layer 8 to the non-polar solvent and the luminescent layer forming material, it is preferable to perform a surface reforming process before forming the luminescent layer.

This surface reforming process is performed by drying a surface reforming material, being the same solvent as the non-polar solvent of the first solution 80 used when forming a luminescent layer, or a similar solvent, after being coated onto the positive hole injection layer 8 by an inkjet method (droplet discharge method), a spin coating method or a dip method.

Examples of the surface reforming material used here are cyclohexylbenzene, dihydrobenzofuran, trimethylbenzene, tetramethylbenzene, and the like, and examples of the same kind of non-polar solvents to the second solution 90 are toluene, xylene, and the like.

Especially in the case of coating by an inkjet method, it is preferable to use dihydrobenzofuran, trimethylbenzene, tetramethylbenzene, cyclohexylbenzene, or a mixture of them, preferably the same mixture as the second solution 90, or the like, and in the case of a spin coating method or a dip method, it is preferable to use toluene, xylene or the like.

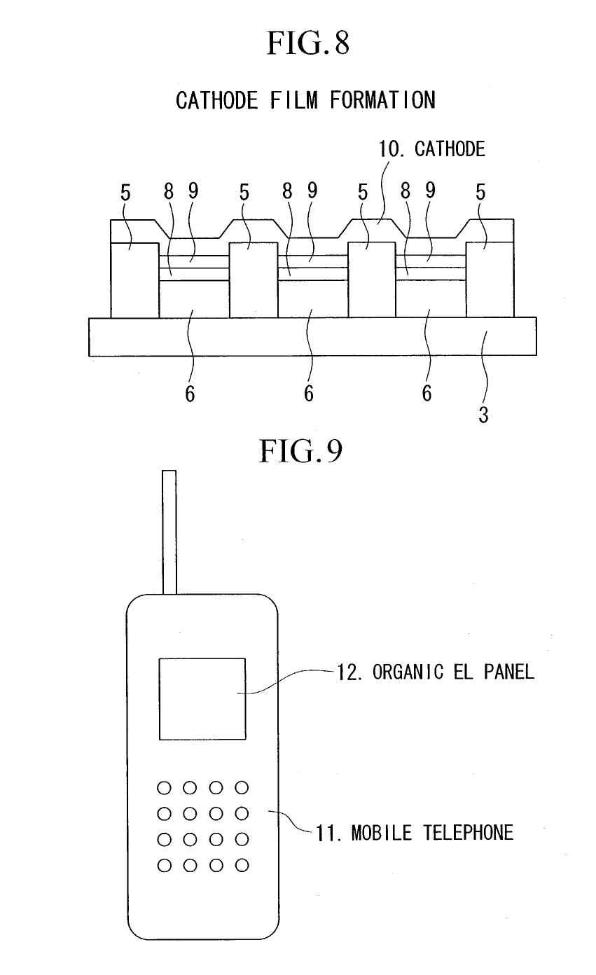

FIG. 8 shows a cathode forming process. After the positive hole injection layer 8 and the luminescent layer 9 films are formed, a cathode film is formed. Firstly, an insulating material film is formed with a thickness of 0.1 to 10 nm. It is preferable to use LiF, NaF, KF, RbF, CsF, FrF, MgF₂, CaF₂, SrF₂, BaF₂ or the like for this material. Next, a film of a material with a low work function is formed. In a case of using macromolecules such as polydialkylfluorene and the like for the luminescent layer 9, it is preferable to use Li, Ca, Sr, Ba or the like, and in a case of using micromolecules, such as an aluminoquinolinium complex and the like for the luminescent layer 9, it is preferable to use Mg or aluminum. For a film production method, it is possible to use a metal film forming method, such as an evaporation method, a sputtering technique, ion plating and the like, and since the evaporation method is the most gentle way of forming a film, it results in good characteristics.

Subsequent to the cathode forming process, sealing is performed. For a sealing process, it is possible to use a method in which an adhesive is applied to attach a protective substrate after forming a passivation film such as fluoride, SizOxNy (x=0 to 2, y=0 to 4, z=1 to 3), and the like on the cathode, or a method in which after forming the cathode, an adhesive is applied around the cathode to attach a can onto which a desiccant is affixed. Furthermore, only a passivation film may be formed on the cathode.

Here, the present invention is not limited to the above-described embodiment, and any modifications which do not depart from the gist of the present invention are possible.

For example, in the above-described embodiment, as an example of a thin film forming method, a method for forming a laminate of a positive hole injection layer and a luminescent layer is described. However, the present invention is applicable to forming a single layer or a laminate of three layers. Furthermore, the device to be formed is also not limited to a luminescent device such as an organic EL device and the like as mentioned above. For example, it is also possible to form a thin film transistor using a solution of a conductive material or a semi-conductive material. Needless to say, it is possible to construct a wiring only layout.

[Embodiment 1]

An example of an organic EL device will be described. A clear glass with a TFT substrate, an ITO electrode, and a polyimide resin bank were used, where the thickness of the ITO was 100 nm, and the thickness of the resin bank was 2 μm. The surface of this substrate was hydrophilic treated by a UV (ultraviolet light with a wavelength of about 174 nm) excimer lamp and air at atmospheric pressure, afterwards the introduced gas was changed to CF₄, and it was irradiated with ultraviolet light from a UV excimer lamp, so that the surface of the resin bank was made water repellent. BytronP, manufactured by Bayer Ltd., was dispensed into all of the picture elements of this substrate by an inkjet method. Next, a 1% xylene solution formed from polydiactylfluorene was dispensed into the blue picture elements of this substrate as a blue luminescent material by the inkjet method. Furthermore, a 1% xylene solution formed from MEH-PPV was dispensed into the red picture elements as a red luminescent material by the inkjet method. Moreover, a 1% xylene solution formed from a PPV derivative was dispensed into the green picture elements as a green luminescent material by the inkjet method. After drying the ink, a 2 nm LiF film was formed, then a 20 nm thick Ca film was formed. Subsequently, a film of aluminum 200 nm in thickness was formed. Then, sealing was performed using a can by the method described previously.

### [COMPARATIVE EXAMPLE]

A panel was created wherein the hydrophilic treatment and the water repellency treatment were performed by atmospheric pressure plasma, according to Embodiment 1.

The half life of the organic EL device created in embodiment 1 from an initial brightness of 100 Cd/m² was 100 hours (30 hours in a conventional example). Furthermore, the occurrence of dark spots was a half or less.

[Embodiment 2]

In the present embodiment, an example is shown in which the organic EL device created in embodiment 1 was fitted into a mobile telephone. FIG. 9 shows a mobile telephone of the present embodiment. An antireflective film was installed on the surface of the organic EL device of embodiment 1, a conductive tape was installed as a contact electrode and connected to a drive circuit, and it was mounted in a mobile telephone case. Compared with a case where a conventional organic EL device was installed, the life of the display panel was increased significantly, and the spots were decreased. If it is used as a display panel of an electric (electronic) device other than a mobile telephone, such as a display panel of a printer, a display panel of a digital camera, a display panel of a video camera and the like, there is a similar effect.

1. A method of treatment for water repellency for treating the surface of a substrate for water repellency, wherein ultraviolet irradiation is performed in a state where the substrate is exposed in an atmosphere of a fluoride-containing gas.

2. A method of treatment for water repellency according to claim 1, wherein said ultraviolet irradiation is performed with a wavelength of 300 nm or less.

3. A method of treatment for water repellency according to claim 1, wherein said fluoride-containing gas contains at least one of a fluoride substitution product of methane gas, a fluoride substitution product of ethylene gas, and a gas in which fluorine is combined with hetero atoms.

4. A thin film forming method for forming a thin film in a predetermined region on a substrate, comprising:
a partition forming process for forming a partition from an organic film on said substrate so as to surround said predetermined region,
a water repellent treatment process for irradiating said partition with ultraviolet light in a state where said substrate is exposed in an atmosphere of a fluoride-containing gas,
a discharge process for discharging a solution in which said thin film material is dissolved into the region surrounded by said partition, and
a drying process for drying said solution and removing the solvent.

5. A thin film forming method for forming a laminate of thin film in a predetermined region on a substrate, comprising:
a partition forming process for forming a partition from an organic film on said substrate so as to surround said predetermined region,
a water repellent treatment process for irradiating said partition with ultraviolet light in a state where said substrate is exposed in an atmosphere of a fluoride-containing gas,
a discharge process for discharging a solution in which said thin film material is dissolved into the region surrounded by said partition, and
a drying process for drying said solution and removing the solvent,
and a laminate of thin film is formed by repeating said discharge process and said drying process while changing said thin film material.

6. A thin film forming method according to claim 4, wherein said fluoride-containing gas contains at least one of a fluoride substitution product of methane gas, a fluoride substitution product of ethylene gas, and a gas in which fluorine is combined with hetero atoms.

7. A thin film forming method according to claim 5, wherein said fluoride-containing gas contains at least one of a fluoride substitution product of methane gas, a fluoride substitution product of ethylene gas, and a gas in which fluorine is combined with hetero atoms.

8. A thin film forming method according to claim 4, wherein the ultraviolet irradiation in said water repellent treatment process is performed with a wavelength of 300 nm or less.

9. A thin film forming method according to claim 5, wherein the ultraviolet irradiation in said water repellent treatment process is performed with a wavelength of 300 nm or less.

10. A thin film forming method according to claim 4, wherein a hydrophobicity process for irradiating said substrate surface with ultraviolet light, in a state where said substrate is exposed in an atmosphere of an oxygen-containing gas that generates active oxygen radicals by ultraviolet irradiation, is provided between said partition forming process and said water repellent treatment process.

11. A thin film forming method according to claim 5, wherein a hydrophobicity process for irradiating said substrate surface with ultraviolet light, in a state where said substrate is exposed in an atmosphere of an oxygen-containing gas that generates active oxygen radicals by ultraviolet irradiation, is provided between said partition forming process and said water repellent treatment process.

12. A thin film forming method according to claim 10, wherein the ultraviolet irradiation in said hydrophobicity process is performed with a wavelength of 300 nm or less.

13. A thin film forming method according to claim 11, wherein the ultraviolet irradiation in said hydrophobicity process is performed with a wavelength of 300 nm or less.

14. A thin film forming method according to claim 10, wherein a process for scrubbing the surface of said substrate to clean it is provided between said partition forming process and said hydrophobicity process.

15. A thin film forming method according to claim 11, wherein a process for scrubbing the surface of said substrate to clean it is provided between said partition forming process and said hydrophobicity process.

16. A thin film forming method according to claim 4, wherein said discharge process is performed using an ink jet method.

17. A thin film forming method according to claim 5, wherein said discharge process is performed using an ink jet method.

18. A manufacturing method of an organic EL device having a structure in which at least a luminescent layer is sandwiched between a first electrode and a second electrode, wherein a resin bank is formed on a substrate so as to surround the first electrode pattern, the surface of this substrate is irradiated with ultraviolet light while exposed in an atmosphere of oxygen-containing gas, and is then irradiated with ultraviolet light while exposed in an atmosphere of fluoridated gas, then positive hole injection material and/or luminescent material films are formed, then subsequently a cathode forming process, and furthermore a sealing process are performed.

19. A manufacturing method of an organic EL device according to claim 18, wherein said fluoride-containing gas contains at least one of a fluoride substitution product of methane gas, a fluoride substitution product of ethylene gas, and a gas in which fluorine is combined with hetero atoms.

20. A manufacturing method of an organic EL device according to claim 18, wherein said ultraviolet irradiation is performed with a wavelength of 300 nm or less.

21. A manufacturing method of an organic EL device according to claim 18, wherein said method of forming said positive hole injection material and/or said luminescent material films is an ink jet method.

22. A manufacturing method of an organic EL device according to claim 18, wherein immediately before ultraviolet irradiation while exposed in an atmosphere of said gas containing oxygen, the surface of said substrate is cleaned by scrubbing.

23. An organic EL device manufactured using the manufacturing method according to claim 18.

24. An electric device fitted with an organic EL device of claim 23.
